(19) United States
(12) Patent Application Publication
(10) Pub. No.: US 2011/0144841 A1
(43) Pub. Date: Jun. 16, 2011

(54) ELECTRONIC BIKE INTEGRATED SUPPLEMENTAL MOTOR SYSTEM

(76) Inventor: Murray Ruben, Santa Barbara, CA (US)

(21) Appl. No.: 12/639,204

(22) Filed: Dec. 16, 2009

(51) Int. Cl. G06F 19/00; H02K 7/18; F16H 57/00; B62M 23/02

(52) U.S. Cl. 701/22; 310/67 A; 74/411; 180/206

(57) ABSTRACT

An integrated supplemental motor system for e-bikes incorporates a motor stator carried by a fixed axle with a torroidal cavity surrounding the axle. A motor rotor for interaction with the stator is supported by a motor casing rotatable on a plurality of bearings carried by the fixed axle. A torque member is concentrically carried within the torroidal cavity and has a first attachment engaged to a gear cluster for force input and a second resilient attachment for engagement to the motor casing. The torque member is urged by the gear cluster from a first no force position resiliently through a range of motion to a second maximum force position. A first element connected to the torque member has a set of first signal generation interfaces and a second element connected to the motor case has an equal set of second signal generation interfaces. The first and second signal generation interfaces are spaced in relation to the range of motion of the torque member. A sensor detects the consecutive first and second signal generation interfaces. A controller connected to the sensor receives a speed input and an effort input and provides a stator actuation current proportional to the spacing of the detected first and second signal generation interfaces.

### BACKGROUND INFORMATION

1. Field

Embodiments of the disclosure relate generally to the battery powered motors for bicycles and more particularly to embodiments for an integrated motor having an optical torque sensor and motor control electronics housed within a wheel hub case.

2. Background

Battery powered motors for providing propulsion assistance to a bicycle allow users to conveniently use bicycles for commuting as well as pleasure riding by reducing the physical effort required. The motor is controlled by a speed control loop using open or closed loop methods. Open loop methods rely on the user to respond to their pedal effort by manually adjusting the speed control lever. Closed loop systems will respond to pedal effort, but not control that effort, making it difficult to maintain a steady pedal effort under varying load conditions. Furthermore, most conventional motor controllers are more aggressive in their usage of battery energy because they are unable to efficiently recover surplus energy available from the user and/or the bicycle's stored kinetic and potential energy.

The prior art solutions do not provide any capability to control a user's pedal effort independently from the bicycle road speed. All other known solutions do not directly manage the user's effort level. This means the user has no direct control over their effort level, and the bike feels mushy when they attempt to pedal it while the motor is operating. An exemplary attempt to avoid this problem is reflected in U.S. Pat. No. 6,866,111 issued on Mar. 15, 2005 to Dube' et al entitled Method and Apparatus for Proportionally Assisted Propulsion.

Without direct pedal effort control, it is difficult to manage the overall battery power consumption, speed, and the user's pedal effort level. The consequence of less overall control is greater risk of fatigue or injury, and uncertainty in the allowable ride duration. This generally leads to purchasing a larger battery with corresponding greater cost and weight penalties. Failure to predict the battery capacity can lead to over-exertion, pedaling a potentially heavier than normal bicycle back home with an exhausted battery.

It is therefore desirable to provide an integrated supplemental motor system which reduces the user's pedal effort in a controlled manner and allows selective control of both the pedal effort and the desired speed of the bicycle

### SUMMARY

Exemplary embodiments provide an integrated supplemental motor system for e-bikes having a motor stator carried by a fixed axle with a torroidal cavity surrounding the axle. A motor rotor carrying a plurality of magnets for interaction with the stator is supported by a motor casing rotatable on a plurality of bearings carried by the fixed axle. A torque member is concentrically carried within the torroidal cavity and has a first attachment engaged to a gear cluster for force input and a second resilient attachment for engagement to the motor casing. The torque member is urged by the gear cluster from a first no force position resiliently through a range of motion to a second maximum force position. A first element connected to the torque member has a set of first signal generation interfaces and a second element connected to the motor case has an equal set of second signal generation interfaces. The first and second signal generation interfaces are spaced in relation to the range of motion of the torque member. A sensor detects the consecutive first and second signal generation interfaces. A controller connected to the sensor receives a speed input and an effort input and provides a stator actuation current dependent on the spacing of the detected first and second signal generation interfaces.

The exemplary embodiments allow a method for providing supplemental motor power to an e-bike. A motor is provided with a casing and a battery. A torque member is concentrically carried within the motor casing and attached to a gear cluster for force input and resiliently attached to the motor casing. The torque member is urged by the gear cluster from a first no force position resiliently through a range of motion to a second maximum force position. The position of the torque member is measured. An operator input value for torque and an operating input value for speed are received. A pedal effort correction factor and a bike speed correction factor are computed based on measured position of the torque member, the input value for torque and the input value for speed. Power requirements for the motor are then computed based on the pedal effort correction factor and bike speed correction factor.

The features, functions, and advantages that have been discussed can be achieved independently in various embodiments of the present invention or may be combined in yet other embodiments further details of which can be seen with reference to the following description and drawings

### BRIEF DESCRIPTION OF THE DRAWINGS

FIG. 1 is a top section view of the overall motor structure and associated components with gear cluster;

FIG. 2 is side perspective view of the torque plate sensor configuration;

FIG. 3 is a side perspective view of the gear side motor casting with torque plate spring interface;

FIG. 4 is a front perspective view of the gear assembly and torque plate;

FIG. 5 is a side perspective view of the nested torque plate, gear side motor casting and photo wheels;

FIG. 6 is a section perspective view of the integrated electronic controller board for the motor;

FIG. 7 is a block diagram of the control elements for operation of the embodiments described; and

FIG. 8 is a flow chart of DSC control and processing for the motor control.

### DETAILED DESCRIPTION

The embodiments described herein disclose an improved battery operated electric motor and control system for a bicycle, tricycle or any similar human powered vehicle. Such vehicles are all referred to herein with the term e-bike. The motor and motor controller reduce or increase the user's pedal effort in a controlled manner which includes the ability to independently set and maintain the effort level while simultaneously managing the operating speed of the e-bike.

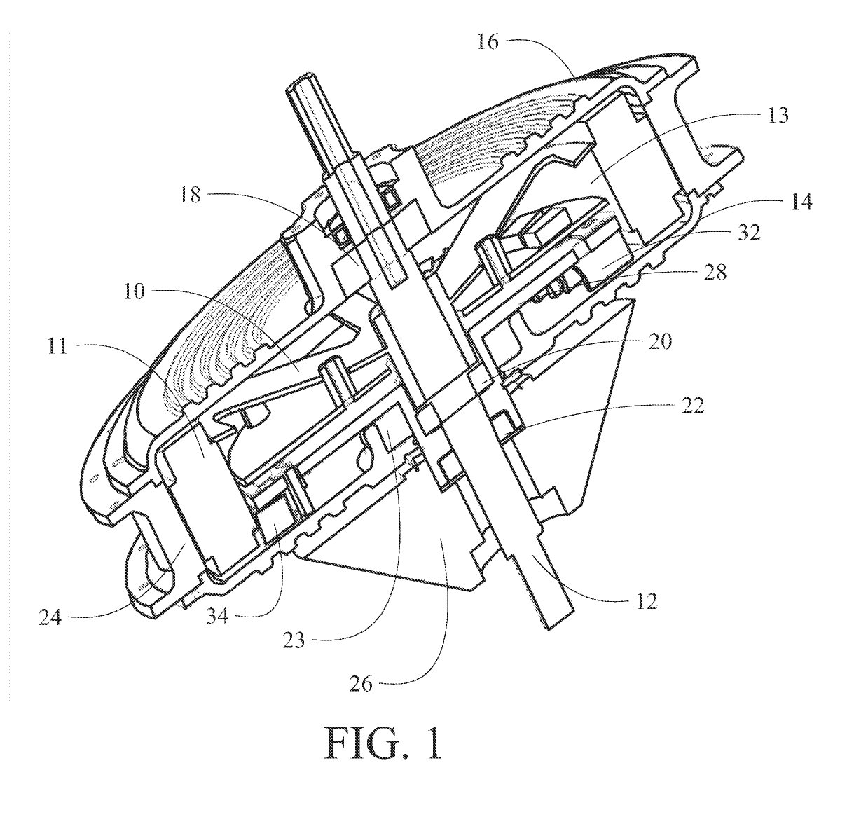

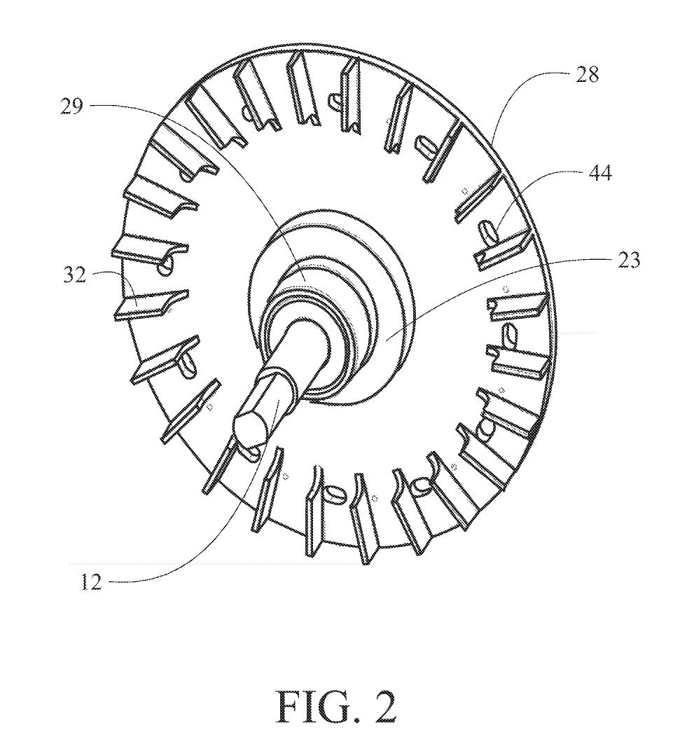

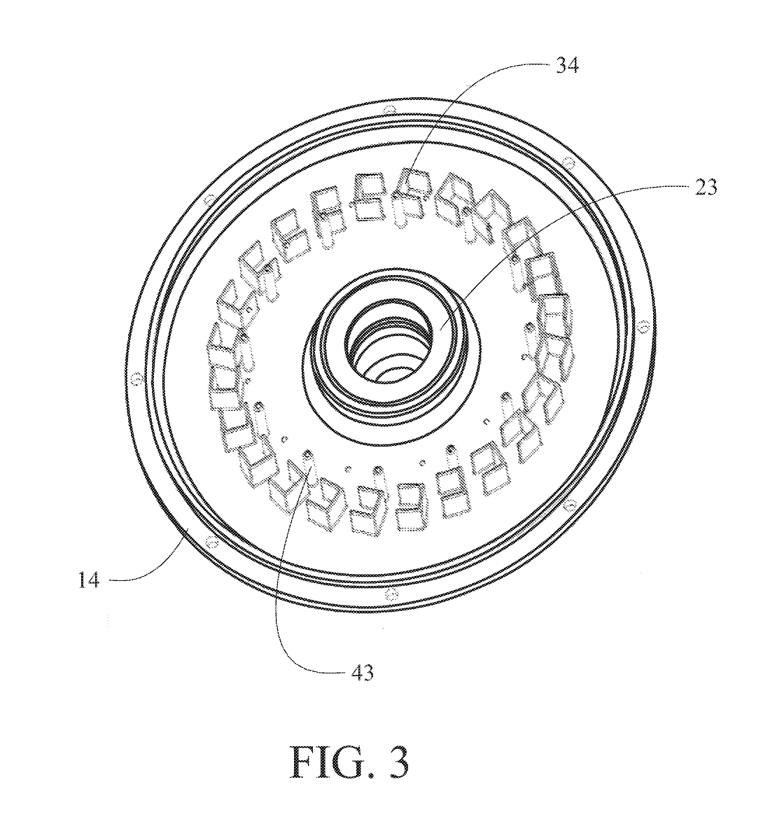

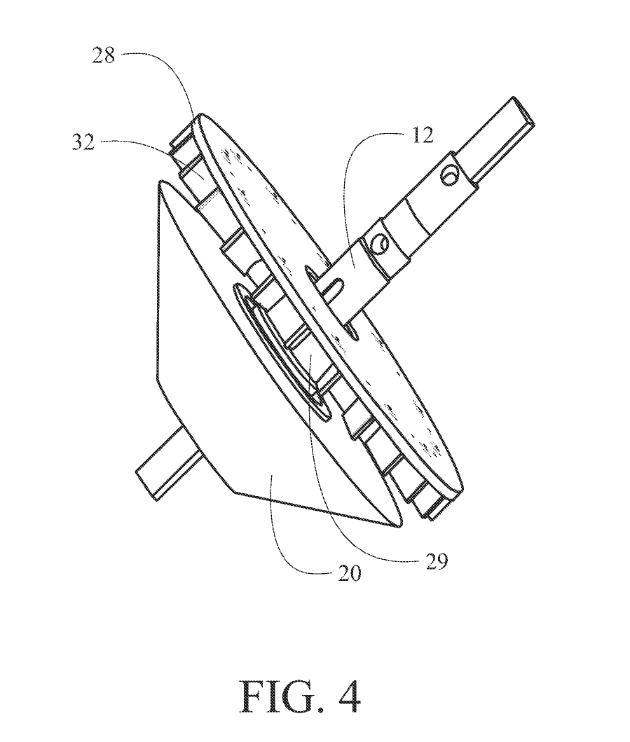

A section view of an embodiment incorporating the present invention is shown in FIG. 1. The integrated brushless direct current motor employs a stationary stator yoke 10 carrying stator windings 11 mounted to a non-rotating axle 12 carried within the rear wheel support frame of a bicycle. The stator yoke is an offset stamping providing a cylindrical cavity 13 around the axle. A split motor case having a gear side casting 14 and an outer side casting 16 encompasses the stator yoke and is rotationally carried by bearings 18, 20, 22 on the axle and motor gear side casting to torque plate bearing 23. Rotor magnets 24 are carried by the motor case for rotation about the stator. A freewheel gear cluster 26 mounted concentrically over the nonrotating axle provides for rotating input from the user with a standard pedal and chain interface. The gear cluster engages a resilient torque member, for the described embodiment a torque plate 28 carried within the cavity of the stator yoke by a stern 29 concentric to the axle (as shown in detail in FIG. 4). A resilient coupling connects the torque plate to the gear side motor casting, which, for the exemplary embodiment comprises springs 30 (best seen in FIG. 3), engaged between vanes 32 extending outward on the torque plate and compression spring wells 34 extending inward from the gear side motor casting. In FIG. 3 for clarity of other elements, only one spring is shown as exemplary for the embodiment where springs are provided in each spring well 34. Details of the torque plate and gear side motor casting are shown in FIGS. 2 and 3 respectively. In alternative embodiments alternative angularly resilient coupling between the torque plate and motor casting may be employed.

Returning to FIG. 1, torque on the gear cluster 26 applied by the user through the pedals is transmitted to the torque plate 28. The resilient interface, in turn, transfers the torque to the gear side motor casting which will impart a rotational force to the motor case. Angular displacement between the torque plate and gear side motor casting is in direct proportion to the applied pedal pressure and provides a measurement for torque applied by the user. For the embodiment shown herein using springs 30, the torque plate operates through a range of motion from the unloaded spring length at zero applied torque to a maximum compression of the springs at a maximum torque. Support bearing 23 transfers rotational loads from the gear side motor casing to the torque plate stem while bearing 20, substantially concentric with bearing 23 and transferring of the torque plate stem load to the axle, and outboard spaced bearing 22, concentric with the envelope of the gear cluster, maintain the concentricity of the gear side motor casting, torque plate stem, gear cluster and axle.

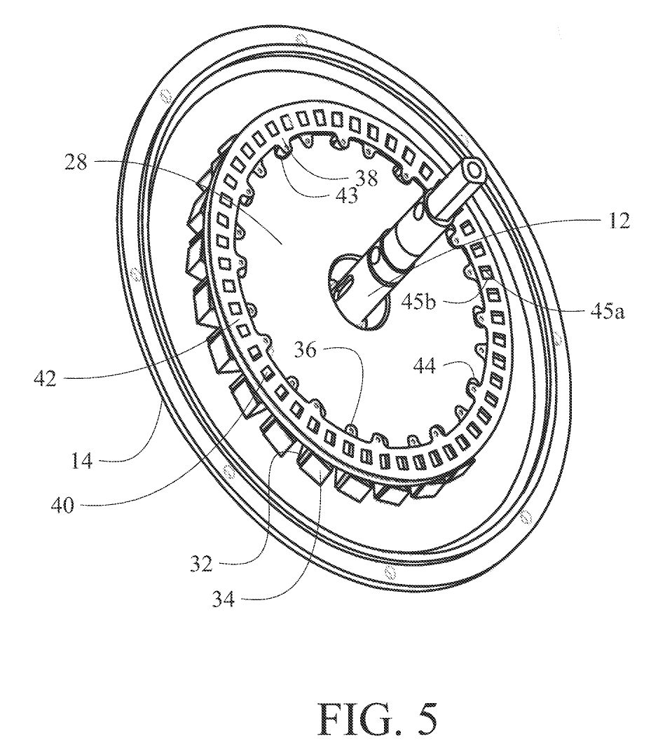

For the embodiment described as shown in FIG. 5 angular displacement between the torque plate and gear side motor casing is measured by a pair of photo wheels 36, 38 containing a uniform circumferential series of open windows 40 and blocking vanes 42 mounted in front of a reflective surface. In alternative embodiments reversal of the reflective and matte surfaces may be employed to form the windows. First photo wheel 36 is attached to the torque plate 28 and second photo wheel 38 is attached by standoffs 43 extending through slots 44 in the torque plate to the gear side motor casting. The windows are arranged and aligned so each open window segment begins with the leading window edge of the wheel attached to the motor casting and ends with the trailing window edge of the wheel attached to the torque plate thereby adjusting the window width based on the angular displacement between the torque plate and motor casting. The leading edge 45a of the window provides a direct reference for speed of rotation of the wheel since the gear side motor casting to which it is attached rotates directly with the wheel. Direct attachment to the gear side motor casting additionally allows the leading edge to directly correspond to position of the magnets 24 of the motor and for the embodiment shown, the number of windows in the photo wheels corresponds to the number of magnets in the motor. The exemplary embodiment uses a motor with 48 magnets and 24 spring wells. The trailing edge 45b of the window provides a torque reference measurement which constitutes a range from a zero applied torque to a maximum torque value corresponding to the maximum angular deflection of the torque plate (maximum compression of the springs 30 as previously described). In alternative embodiments the photo wheels may employ a greater or lesser number of windows. In one exemplary embodiment, 72 windows corresponding to all three phases of the pole pairs of the magnets may be employed.

A phase transition event pair consists of a rising edge event time and a corresponding immediately following falling edge event time. From event pairs a number of variables can be obtained for control of the system as will be described in greater detail subsequently.

The instantaneous rotor angular position is derived from the leading edge event. The leading edge of each optical window is directly referenced to the relative angular position of the motor rotor. The absolute rotor rotation angle can then be determined by counting leading edge events starting from an initial reference reset event.

The instantaneous rotor magnet position and corresponding motor phase timing may also be deduced. The number of optical windows, and hence leading edges, is arranged to relate to the number of magnets attached to the motor rotor. Therefore, each leading edge event restores the multi phase motor power controller to a known physical rotor electrical angle position and a known motor control reference power state. The timing of the remaining motor phase angle positions is estimated by dividing the time between the previously stored leading edge and the current leading edge by the number of motor phases per magnet. For a three phase motor, the divisor will be three. For precise control, an estimation can include compensation for incremental changes in the average rotor rotational speed, as described later. Incremental changes in average rotor rotational speed tend to be very small owing to the very small angular movement between adjacent optical window event pairs. Other correction factors may also be employed, such as the well known “sensor-less” motor position method that relies upon detection of motor phase winding zero crossings as will be described in greater detail subsequently.

In a gearless permanent magnet DC motor, the rotation of the rear bicycle wheel is synchronous to the rotation of the motor rotor and therefore the instantaneous rear wheel position is known. If d is the wheel diameter in inches (or meters) and N is the number of complete optical windows per 360 degrees rotation of the rotor, then the bicycle will travel (pi*d)/N inches (or meters) in the time between two successive leading edge optical window events. For example, if d=27 inches, and N=48 optical windows, then the rear wheel will have traveled (27*3.14)/48=1.77 inches in the time required to detect two successive optical window leading edge events. This very fine level of motion sensing permits virtually instantaneous response to any changes in the e-bike motion, also discussed further below. The traveling distance, D, of the e-bike can be obtained by keeping a count of the number of leading edge events with respect to an initial reset position.

The instantaneous e-bike speed and e-bike acceleration or deceleration may also be deduced. The e-bike speed is computed as the distance traveled, D, (as described above) divided by the time required to travel that distance. The time is determined by computing and summing the incremental event times of each leading edge transition. A reasonably accurate estimate of the e-bike's acceleration or deceleration can be obtained by evaluating each leading edge event with respect to the preceding leading edge events. A e-bike traveling at a steady speed will produce leading edge events that occur at a constant rate. A e-bike that is accelerating will produce leading edge events that occur at increasingly shorter time intervals. The opposite is true of a e-bike that is decelerating.

The instantaneous pedal force is directly proportional to time between a leading edge event and the next trailing edge event, corrected if necessary for acceleration or deceleration effects. As explained previously with regard to c-bike speed and acceleration deceleration, it is possible to determine whether a e-bike is traveling at a steady, increasing, or decreasing speed. Ata steady speed, the trailing event is not modified by e-bike changes in motion, and the time between the leading edge and trailing edge is directly related to the pedal force by the equivalent elastic constant of the resilient torque plate arrangement. An accelerating e-bike will present the trailing edge slightly earlier in time when compared to a e-bike traveling at a steady speed. A decelerating e-bike will similarly present the trailing edge slightly later in time when compared to the steady e-bike speed condition. The e-bike control logic can measure and apply appropriate correction factors to the pedal torque calculation using the acceleration/deceleration information, as described previously, when required.

The current gearing ratio between the pedal and the wheel and the user's actual pedal force effort may also be determined. A user operating a pedal powered e-bike will exert maximum pedal force when the pedals are approximately horizontal, and minimum force when the pedals are vertical. As the user pushes on the pedals, an oscillating motion is produced in the elastic members of the torque plate. This oscillating motion will be detected as described previously with respect to the determination of instantaneous pedal force. Using the method described to calculate the wheel travel distance between detected maximum and minimum force events, it is possible to determine the distance traveled per pedal stroke. This information can then be used to deduce the effective gearing ratio between the pedal and the wheel. Finally, the gearing ratio and direct measurement of the pedal force at the torque plate (the output torque produced by the pedal effort) can then be used to deduce the user's actual input pedal force effort. Pedal effort can be maximum pedal force or average rider energy input. The user's average energy output can be computed as a function of the user's measured average pedal force (torque) and pedal speed.

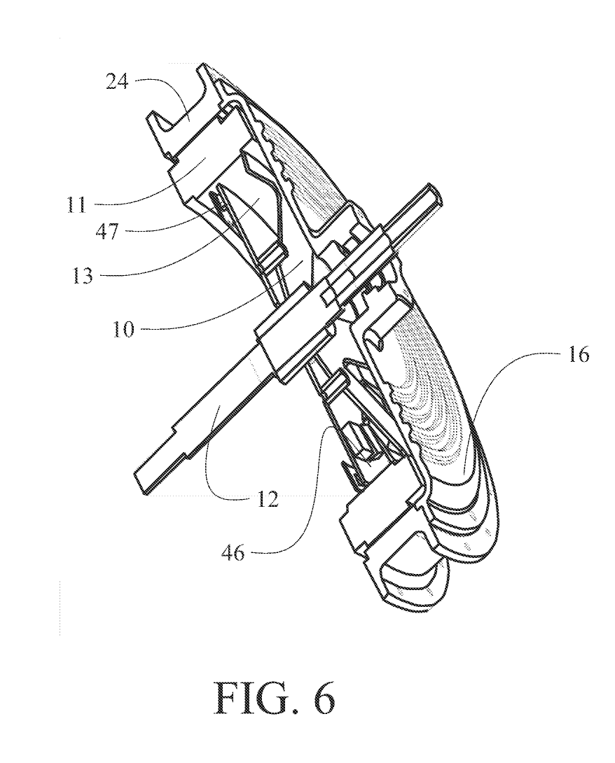

A motor controller board 46, shown in detail in FIG. 6 is mounted to stator yoke 10 within the cylindrical cavity 13 and incorporates an optical detector 47 for the photo wheel windows. By reading the combined optical window openings passing above the optical sensor mounted on the motor controller, a repetitive square wave type signal is generated where the leading edge (corresponding to the leading edge 54a of the window) always represents the rotor position. The trailing edge is of the signal is displaced relative to the predicted location of the trailing edge 54b of the reference window by an amount determined by the combined transmission spring constant and the instantaneous gear torque (gear force) applied to the torque plate. Counting leading edges provides wheel speed and travel distance information, and also provides a reference signal required to time the application of power to the three phase motor windings allowing the motor to provide supplemental torque for turning the bicycle rear wheel. A first control input from the user to the motor controller sets the relative proportion of overall wheel torque supplied by the user through the pedals/gear cluster and the electric motor through powering of the stator windings to achieve a desire speed set by the user through a second control input as will be described in greater detail subseuqently

Sensor methods other than the preferred optical reflective interrupter method can be employed. These include, but are not limited to, magnetic methods incorporating reluctance or hall flux detectors, and optical transmission interrupter methods. The invention would pertain to the use of any of these equivalent angular displacement detection methods.

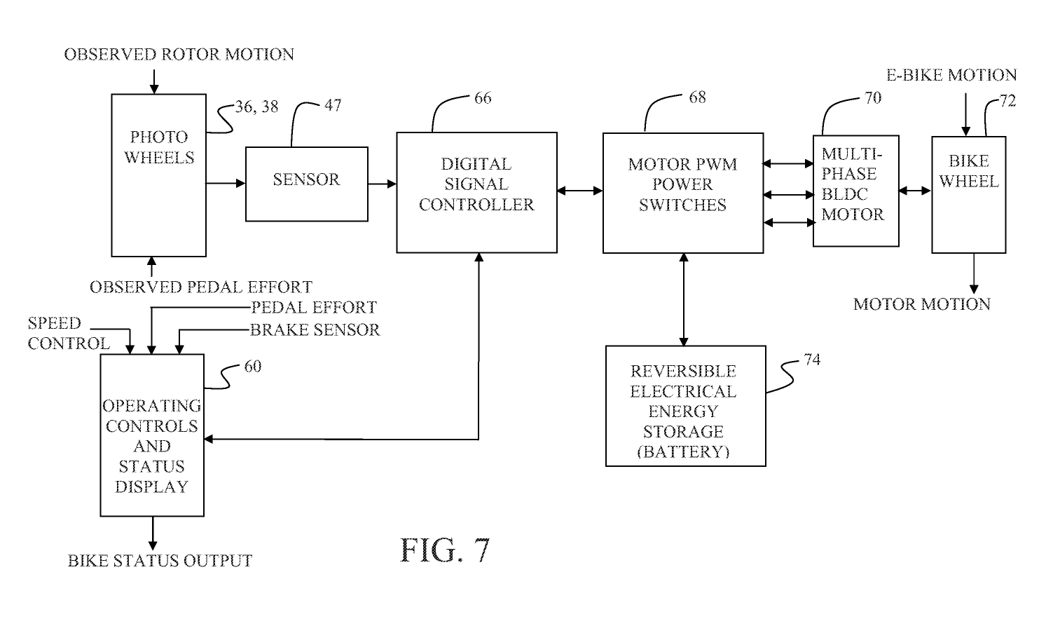

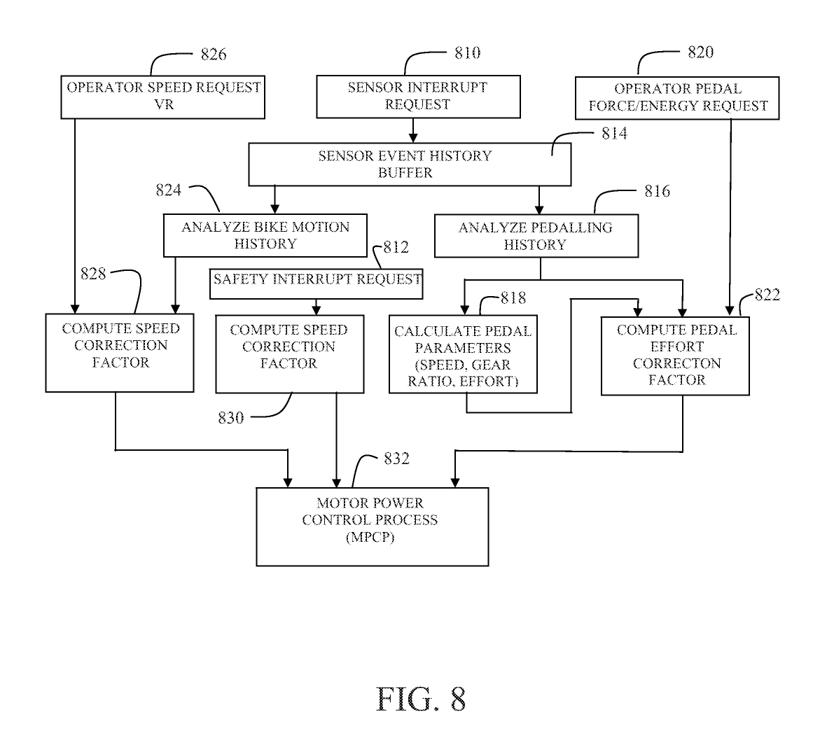

As shown in FIG. 7, the elements of the motor controller include the optical detector 47 which receives the observed rotor motion and the torque provided by the user pedal effort through the photo wheel windows 36 and 38 described above with respect to FIG. 5. A control and status display unit 60 is mounted to the e-bike in a location convenient to the user and receives one or more speed control inputs 62 (such as a maximum speed and a minimum speed) set by the user and a pedal effort setting 63 also set by the user. A brake sensing control 64 is also provided. A digital signal controller (DSC) 66 receives the leading and trailing edges of the input signal from the optical detector and the speed control input[s], pedal effort setting and brake sensing control from the control and status display unit for control of the system as will be described in detail with respect to FIG. 8. The control status and display unit may be employed to define an Operating Profile Mode (OPM) from the speed, pedal effort as described previously or comparable settings. The DSC is a combination of a conventional microprocessor and a digital signal processor for the embodiment shown. DSC 66 controls current to motor power switches 68, for the embodiment shown, a multi-phase, multiple half H-Bridge power stage, for activation of multi-phase motor 70, through phase winding of a brushless DC style (BLDC) motor, corresponding to the stator windings 11 carried by stator yoke 10 and the rotor carrying magnets 24 described with respect to FIG. 1. In the embodiment shown, each half H-Bridge power stage is capable of receiving surplus motive energy generated by the motor or user's pedal force and converting that energy for storage back into the battery, also under direct DSC control. The initial implementation of the embodiments shown employs a conventional three phase motor/generator. The methods described herein are not limited to this particular motor phase selection, however.

The motor drives the e-bike wheel 72 by rotation of the gear side motor casting 14 as previously described. Actual motion of the wheel of the e-bike, whether driven by the motor or induced by exterior forces and the motion of the motor rotor, again whether in a driven state or a passive state, is directly rigidly related. Power for the motor power switches is provided by a reversible electrical energy storage device 74 such as a battery. The motor also converts motion of the wheel of the e-bike back into electrical power that can then delivered to the half H-Bridge power stage for subsequent storage in the battery. The amount of recoverable energy can be increased when the DSC commands the half H-bridge power stages to actively exert reverse rotational (breaking) forces to the rear wheel. For energy recovery, the H-bridge operates by shorting all the motor phase windings until a preset current is observed in the windings, using one side (for example the negative side) of the half H-bridge transistors, then quickly opening the switches, which causes the voltage across the windings to jump up to the battery level, where flyback diodes then complete the current transfer back into the battery. The process is repeated at a rate commensurate with the desired resistance level to increase the rider effort level when it otherwise would not be required because the bike already was at the commanded speed.

The control process provided by the DSC is show in detail in FIG. 8. The method for the embodiment disclosed herein uses two control feedback loops, one for e-bike speed and the second for user pedal effort. Other control methods are possible, and they will briefly be summarized later. An interrupt process, step 810, captures optical wheel events and system status readings. The DSC maintains a first interrupt process that responds to each optical detector event. This process creates the basic system status information (rotor position, rear wheel angular speed, e-bike wheel acceleration or deceleration, total distance traveled, e-bike speed, average pedal force, peak pedal force, pedal to wheel gear ratio, pedal cadence, and the user's average energy effort level). The optical detector event process'is only one of several parallel processes performed by the multi-tasking DSC.

A second DSC interrupt process for system status events, step 812, takes periodic readings of the motor, battery, and environmental status (voltages, currents, temperatures, safety switch states provided by convention detectors in the motor system). The motor voltages are primarily used for safety, power regeneration, and efficiency computations. The motor current is primarily used for the same purposes and for determination of the observed motor load torque. The battery voltage and current readings are used to establish and track the battery power level and estimate the battery charge capacity. The environmental readings are primarily used to protect the safety of the user and the e-bike electrical components. They are also used for theft protection. System variable interrupts are generated periodically under the control of a DSC system timer. In some situations, the timer is overridden and the readings are taken in essentially real time.

Each optical detector interrupt event causes data to be stored within the DSC operating memory in an optical detector event history buffer, step 814. Optical wheel interrupts record event times (read from a reference timer) when the optical detector signal generates rising or falling edges, an event pair. The history buffer size is dynamically adjusted to remember enough previous history to accurately discover the user's pedal force profile over approximately the last two pedal revolutions. The DSC main process continuously inspects the history buffer and extracts both pedaling and e-bike motion history information. The extracted information is then combined with the user's requested control settings to generate correction signals. The correction signals form the inputs to the Motor Power Control Process (MPCP) that will be described in greater detail subsequently. This process outputs the desired motor phase control signals and signaling patterns based upon the Operating Profile Mode (OPM) previously defined by the user.

Data from the history buffer is employed by the DSC for analysis of pedaling history, step 816. History buffer samples are examined following each trailing edge event, and the instantaneous pedal force, F, is computed as previously described. F is compared to the corresponding value stored in the previous stroke buffer FP(t), and then saved in the current stroke buffer, F(t). Each F value is inspected to detect maximum (MF) and minimum (MIN) values. The MIN values are used to identify apparent pedal half rotations. The MIN values are used to align the current pedal force profile, F(t), by redefining F(t) as the next FP(t). The MIN values are also used to discover the unassisted motor torque level (a measure of total vehicle energy requirements) since the pedal force is zero during MIN measurements.

FP(t) is then used to compute the average user energy level (E) from the previous pedal stroke, and the estimated pedal speed (W), step 818. Advanced processing techniques are used to handle pedal force boundary conditions such as cessation of pedal force in the middle of a pedal stroke.

User input to the control and status display unit in the form of User Maximum Pedal Force Request (MPF), User Average Energy Effort Request (ER) or Operating Profile Mode (OPM) is accomplished in step 820.

A pedal power correction process operates upon F(t) and FP(t) to compute correction factors based upon differences between FP(t) and F(t) (FP(t)-F(t)), actual and the measured average user power level (ER-E), and a special error factor used to protect the user against excessive pedal force exertion (MPF-MF), step 822.

History buffer samples are also examined following each leading edge event in step 824, and the instantaneous e-bike speed, V, is computed as previously described. V is compared against previously stored values to extract information concerning instantaneous changes in e-bike speed, A. A short history of e-bike motion is maintained sufficient to predict the next few speed samples. Additional information computed during the leading edge analysis events includes a running summation of distance traveled, D.

The recorded time between leading edge samples is used to discover when the e-bike motion has stopped or dropped below a low speed threshold. In a similar manner, the same information can be evaluated to detect when the e-bike has begun to move at a speed above the legal shutoff settings, or when the bike is moving so fast that it exceeds the maximum legal motor assist level. These events are collectively grouped together as the error condition X.

Input of a speed request (VR) by the user to the control and status display unit 62, step 826, may be in the form of cruise control settings or a manual throttle setting. A Bike Speed Correction Factor is then computed, step 828, using as VR-V(A). V(A) is the current e-bike speed adjusted for predicted changes based on the acceleration or deceleration A.

The e-bike safety and theft deterrent interrupt process input is employed in step 830 to compute system safety and theft factors from e-bike safety measurements including battery voltage and existing motor voltages and currents, user hand brake control input as measured by the brake sensing control 64, e-bike theft detection sensors and e-bike starting or stopping status (X).

The Motor Power Control Process (MPCP) is then executed, step 832. The MPCP inspects the inputs from all of the error processes (e-bike speed, safety, and pedal force) and the requested operating profile mode. The output of this process then determines the motor voltage, frequency, phasing, and torque output.

As previously described, the motor (which may also operate as a generator) is connected through the gear side motor casing 14 to directly supply or receive motive power to/from the rear bicycle wheel. It has also been arranged so that it will receive pedal power from the user through the gear cluster 26. The total motive power delivered to the wheel is therefore the sum of the motor and pedal efforts. The pedal effort in this invention is directly measured just before it is added to the motor effort. This provides the ability to directly observe and quantify the pedal effort, and use that measurement in the operating modes described below.

Furthermore, a measurement of the pedal force occurs in synchronism with each application of a power phase sequence to the motor stator windings (i.e., as each magnet rotates into the next phase sequence starting position on the rotor). A power phase sequence is created by dividing the time between leading edge events by the number of motor power phases required to move the rotor by two magnet positions (one pole pair). When using the large diameter rotors common to (relatively slowly rotating) motor designs as in the embodiment disclosed herein, the number of rotor magnets, and hence optical sampling windows, tends to be rather large, for example, 48 magnets. This provides a very accurate measurement of instantaneous motor and pedal status. A power phase sequence in the context of this invention can result in force (torque) being added (by motoring action) or subtracted (by generating action) from the measured pedal force. The combined sum is applied to the rear wheel. In addition to the above motor mode combination process, a separate regeneration mode is always present whereby motive power from the wheel can be extracted by the motor alone operating in generator mode.

The Motor Power Control Process can be used to implement various operating modes (control methods). The first, most advanced operating control method is based upon energy or power flow. A preset level for energy exertion, ER, is requested through the control and status display unit 62 in step 820. Pedal force is not directly controlled in this first method. Instead, the user's average energy input, E, is estimated by combining the measured pedal force and pedal speed. These two variables can be adjusted by the user using an existing conventional Derailleur gear transmission operably connected to the gear cluster 26. The measured user's energy input (effort level) E is compared to the desired energy exertion lever ER, as ER-E which is used to adjust the e-bike system energy flow in order to maintain the user's energy exertion level, ER, at the preset level, while using the motor in either an assistance (motoring) or resistance (generating) mode to meet the commanded e-bike speed objective set in step 826. The motor will resist the user when the bike has reached the requested speed and the user provides an effort level greater than the level needed to maintain that speed. The surplus pedal energy is saved in the battery for future reuse. The motor will assist the user by draining energy from the battery when the user effort level drops below the level needed to maintain the requested bike speed. The user can set or adjust the bike speed using the control and status display unit mounted on the handlebar. In this operating mode, the user cannot control the bike speed using pedal effort alone once the speed is set. However, the user can establish the desired speed by normal pedal gearing methods prior to engaging the speed and effort set points.

For an exemplary embodiment employing a motor controller by Freescale Semiconductors, part no. MC56F8006, as described in Freescale document number DRM 108 Rev. 0 dated April, 2009, the BLDC motor output torque can be measured by measuring the motor current and motor speed. Errors detected in the speed control loop result in changes in the motor current. Knowing the requested pedal torque or effort (ER), and the motor's torque-speed curve or speed-current curve, the MPCP determines how much of the speed error (VR-V(A)) should be provided by adjusting the motor power (current) and how much by the user pedal input.

In a traditional loop, the entire speed error is corrected by motor torque (current/power response) up to boundary current limits. In the exemplary embodiment that response is modified to include the user's requested input, in other words, less motor torque is commanded if the user is slightly below their set effort level, and the result will be either the user will increase their effort to bring the e-bike back to speed, or the e-bike will run slower than its commanded speed, down to a minimum speed level (the coasting or motor only speed) if the user set that level. (All set point speeds, especially the minimum, are released by any manual breaking actions).

When the opposite occurs, and the e-bike speed exceeds the speed set point, the motor will resist the user's pedal effort up to the commanded user effort level (ER). If the e-bike's stored energy is less than the maximum pedal effort level, the user will have to continue pedaling to maintain e-bike speed. Otherwise the e-bike will slow down by breaking action to its lower speed set point at which time the motor resistance will be controlled solely by the minimum speed and the user can rest. Should the e-bike's stored energy exceed the maximum motor resist level, the e-bike will begin to speed up and require manual braking.

Once the e-bike speed reaches its comparative motor assist level, the motor ceases assisting and may, depending on the users choice, begin resisting up to the commanded torque level. User effort above this max resistance level will result in the e-bike actual speed increasing.

This first control strategy can also be applied when the e-bike is setup to be used as a gym exercise bicycle by holding the bike frame in a support stand that allows the rear wheel to freely rotate without contacting any fixed surfaces. Almost all of the user's energy input is consumed by the generator load. An extra power dump load, such as a conventional light bulb, may be provided in this configuration to prevent overcharging a full battery.

A second operating control method, based upon pedal force or torque, can be implemented by the MPCP to amplify the measured pedal force by a fixed, user selected amplification factor while disabling the speed control loop. This second method uses the user's pedal inputs to control the bike speed and is an electronic equivalent of a manual gear shifting scheme. This second method can be modified so that a fixed amplification factor is applied until the pedal force reaches a preset maximum level, above which the motor power amplification factor is rapidly increased in order to keep the pedaling force effort approximately steady. The user will still be able to control speed by varying the pedal speed. A maximum speed setting can optionally be added to this second operating profile to cause the motor to begin resisting the user (increasing their effort level and saving the excess energy in the battery) once the bike gets to the desired speed setting. This resistance effort would cease once the user's effort reaches the maximum limit, whereupon the power flow reverts back to assistance (motor) mode and the bikes speed would increase (until motor cutoff speed is reached).

An additional variation in the second method is possible whereby a second resistance level is supplied to define a lower limit pedal force effort. In this variation, the assistance mode remains operative as described above until the pedal force drops below the lower limit, whereupon the system switches to resistance mode in an attempt to slow the bike down while maintaining the commanded minimum pedal effort. Surplus energy produced by the resistance of the motor (now acting as a generator) is returned to the main battery storage element. The user may add a speed limit input to this variation of the second process to reactivate the assistance mode once the bike speed drops below a preset minimum speed, so the bike retains a minimum speed setting (until it is modified by throttle or braking actions) when the user stops pedaling.

Still another operating control method is possible using a conventional speed control speed setting to establish the e-bike speed. This mode does not attempt to control the pedal effort, but it does measure that effort and recover excess bike momentum and excess pedal effort by switching to resistance once the requested bike speed objective is exceeded. The excess energy is stored back into the battery for future re-use. In this third control mode, the bike speed is controlled by the throttle or cruise control speed setting and not by the pedaling effort.

Other control modes are possible using the DSC of this invention since the Motor Power Control Process operates entirely in a digital processor device, using conventional software programming techniques, and virtually all of the information needed to create and control the bicycle energy flow and speed objectives are available using the measurement methods of this invention. New control modes can be created by simply combining the measurements in a new manner and changing the software accordingly. No hardware changes would normally be required.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. An integrated supplemental motor system comprising:
a motor stator carried by a fixed axle and having a torroidal cavity surrounding the axle;
a motor rotor carrying a plurality of magnets for interaction with the stator, the rotor supported by a motor casing rotatable on a plurality of bearings carried by the fixed axle;
a torque member concentrically carried within the torroidal cavity and having a first attachment engaged to a gear cluster for force input and a second resilient attachment for engagement to the motor casing said torque member urged by the gear cluster from a first no force position resiliently through a range of motion to a second maximum force position;
a first element connected to the torque member and having a plurality of first signal generation interfaces and a second element connected to the motor case and having an equal plurality of second signal generation interfaces, said first and second signal generation interfaces spaced in relation to the range of motion of the torque member;
a sensor for detecting consecutive first and second signal generation interfaces; and,
a controller connected to the sensor, said controller receiving a speed input and an effort input and providing a stator actuation current dependent on the spacing of the detected first and second signal generation interfaces.

2. The integrated supplemental motor system as defined in claim 1 wherein the torque member comprises a torque plate having a plurality of extending vanes and an equal plurality of springs engaged between the vanes and an equal plurality of wells extending from the casing, said first position in the range of motion corresponding to an extended position of the springs and said second position in the range of motion corresponding to a compressed position of the springs.

3. The integrated supplemental motor system as defined in claim 1 further comprising a motor controller board carried within the torroidal cavity, said controller and said sensor mounted to the board.

4. The integrated supplemental motor system as defined in claim 2 wherein the sensor is an optical sensor, the first element comprises a first photo wheel having a plurality of uniform circumferential series of open windows and blocking vanes each window having a leading edge as the first signal generation interface and the second element comprises a second photo wheel having an equal plurality of second windows and vanes overlapping the windows and vanes of the first photo wheel with each second window having a trailing edge as the second signal generation interface, the angular rotation of the torque plate altering the spacing between the leading edges and trailing edges of the first and second photo wheel windows respectively

5. The integrated supplemental motor system as defined in claim 4 wherein the plurality of windows is directly proportional to the plurality of magnets.

6. The integrated supplemental motor system as defined in claim 4 wherein the plurality of windows is equal to a number of pole pairs of the plurality of magnets.

7. The integrated supplemental motor system as defined in claim 5 wherein the plurality of windows is a multiple of a number of pole pairs of the plurality of magnets

6. The integrated supplemental motor system as defined in claim 2 wherein the torque plate incorporates a stem extending through the motor case for engagement to the gear cluster.

8. The integrated supplemental motor system as defined in claim 5 further comprising a first bearing rotationally supporting the motor case on the axle opposite the gear cluster, a second bearing intermediate the motor case and torque plate stem and a third bearing intermediate the torque plate stem and axle.

9. The integrated supplemental motor system as defined in claim 6 wherein the second bearing and third bearing are substantially concentric and further comprising a fourth bearing intermediate the torque plate stem and axle within an envelope of the gear cluster.

10. A method for providing supplemental motor power comprising:
providing a motor with a casing and a battery;
providing a torque member concentrically carried within the motor casing;
attaching the torque member to a gear cluster for force input;
attaching the torque member resiliently to the motor casing said torque member urged by the gear cluster from a first no force position resiliently through a range of motion to a second maximum force position;
measuring the position of the torque member;
receiving an operator input value, for torque;
receiving an operating input value for speed;
computing a pedal effort correction factor;
computing a bike speed correction factor; and
computing motor power requirements for the motor based on the pedal effort correction factor and bike speed correction factor.

11. The method for providing supplemental motor power of claim 10 wherein the step of measuring the position of the torque member comprises:
sensing leading edge signals from a plurality of first signal generation interfaces and trailing edge signals form an equal plurality of second signal generation interfaces, said first and second signal generation interfaces spaced in relation to the range of motion of the torque member.

12. The method for providing supplemental motor power of claim 11 further comprising:
storing the sensed leading edge signals in a vehicle motion history buffer; and
storing the trailing edge signals in a pedaling history buffer.

13. The method for providing supplemental motor power of claim 12 wherein the step of computing a pedal effort correction factor includes
analyzing data in the pedaling history buffer for a current pedal force and profile by computing the instantaneous pedal force, F, based on time between a leading edge signal and the next trailing edge signal; and
comparing F to the corresponding value stored in a previous stroke buffer FP(t), and then saving in the current stroke buffer, F(t).

14. The method for providing supplemental motor power of claim 13 wherein the step of computing a bike speed correction factor includes
calculating a current instantaneous speed, V, from incremental event times of each leading edge transition and subtracting that value from the operating input value for speed.

15. The method for providing supplemental motor power of claim 14 wherein the step of computing the pedal effort correction factor further includes
using FP(t) to compute the average user energy level (E) from the previous pedal stroke.

16. The method for providing supplemental motor power of claim 15 wherein the received input value for torque is a desired energy level (ER) and the step of computing motor power requirements comprises
adjusting current flow between the battery and the motor proportional to ER-E using the motor in a selected one of motoring or generating mode to meet the input value for speed.

17. The method for providing supplemental motor power of claim 16 further comprising directing current in the motor generating mode to the battery for future reuse.

18. A supplemental motor system for an e-bike comprising:
a motor stator carried by a fixed axle and having a torroidal cavity surrounding the axle;
a motor rotor carrying a plurality of magnets for interaction with the stator, the rotor supported by a motor casing rotatable on a plurality of bearings carried by the fixed axle;
a torque plate concentrically carried within the torroidal cavity and having a stem extending through the motor case for engagement of a gear cluster for force input and having a plurality of extending vanes;
an equal plurality of springs engaged between the vanes and an equal plurality of wells extending from the motor casing, said torque plate urged by the gear cluster from first position in a range of motion of the torque plate corresponding to an extended position of the springs to a second position in the range of motion corresponding to a compressed position of the springs urged by the gear cluster;
a first bearing rotationally supporting the motor case on the axle opposite the gear cluster, a second bearing intermediate the motor case and torque plate stem and a third bearing intermediate the torque plate stem and axle, the second bearing and third bearing substantially concentric and a fourth bearing intermediate the torque plate stem and axle within an envelope of the gear cluster;
a motor controller board carried within the torroidal cavity;
a first photo wheel having a plurality of uniform circumferential series of open windows and blocking vanes each window having a leading edge and a second photo wheel having an equal plurality of second windows and vanes overlapping the windows and vanes of the first photo wheel with each second window having a trailing edge, the angular rotation of the torque plate altering the spacing between the leading edges and trailing edges of the first and second photo wheel windows respectively
an optical sensor mounted on the motor controller board for detecting consecutive leading and trailing edges of the first and second photo wheel windows; and,
a controller connected to the sensor, said controller receiving a speed input and an effort input and providing a stator actuation current proportional to the spacing of the detected consecutive leading and trailing edges.
